(19) United States
(12) Patent Application Publication
(10) Pub. No.: US 2012/0251682 A1
(43) Pub. Date: Oct. 4, 2012

(54) Device and method for producing mixed drinks by means of electromagnetic radiation

(76) Inventor: Hendrik Sebastian Meyl, Munchen (DE)

(21) Appl. No.: 13/515,502

(22) PCT Filed: Dec. 7, 2010
(86) PCT No.: PCT/EP10/07437

§ 371 Date: Jun. 13, 2012

(30) Foreign Application Priority Data
Dec. 14, 2009 (DE) 10 2009 058 240.1

(51) Int. Cl. A47J 31/00; A23F 5/00; A47J 31/44

(52) U.S. Cl. 426/241; 99/291; 99/287

(57) ABSTRACT

The invention relates to a method with an accompanying brewing system for preparing a mixed drink from two or more drink components, wherein the mixed drink is made up in a collecting container and at least two drink components are prepared by means of electromagnetic radiation. The drink components are prepared in successive steps, and different drink components are on no account exposed simultaneously to electromagnetic radiation. In order to prepare each drink component, the same collecting container is always used for direct collection of the drink components and the drink components already prepared remain in the collecting container during preparation of subsequent drink components.

The present application claims priority of German patent application DE 10 2009 058 240.1.

The invention relates to the field of brewing systems for preparing a single portion of a mixed drink by means of electromagnetic radiation. A single portion of a drink is defined by the quantity, prepared exactly for one person for the immediate consumption. In general, the wavelength of the electromagnetic radiation used is within the centimeter range (microwaves).

A mixed drink contains more than one, usually also single consumable drink components, which are combined in a drinking vessel. This combination of the drinking components contains a mixture or layering, wherein these models can be combined randomly. For example the cappuccino, wherein hot milk and espresso are mixed in equal parts, and wherein a layer of milk foam covers this mixture.

This example indicates also a specialty of mixed drinks. The multiple used milk foam is not an independent drink, but is used exclusively in mixed drinks. In this respect, not only the production of milk foam is associated directly with the production of mixed drinks, but is a requirement for many mixed drinks.

The production of mixed drinks can be done in different ways, wherein it can be even different for the same drinks. In order to prepare a cappuccino, the barista in an espresso bar usually brews the espresso first and then the hot milk, resulting from foaming-up the milk, and finally the milk foam from the foaming up pot is added. The drink components are prepared partially in separate brewing containers, for example, the foaming-up pot, for composing in a container afterwards. In contrary, at a fully automatic machine, the milk for one portion gets foamed-up first and then the espresso is brewed in. The drink is prepared afterwards in a single container. In this case, the disadvantage is that the espresso, which flows through the milk foam, discolors the milk foam and collapses it at the flow paths. Once again, there are more containers needed, if the fully automatic machine will perform a composition of the mixed drink as the barista would have mixed the drink

For preparing mixed drinks by means of electromagnetic radiation, there is no comparable brewing system or brewing method.

There should be no disregarding the fact that often the heating of a drink or a brewing fluid for simple drinks by heating the fluid directly in a microwave-fitted container is the easiest and most useful solution. Regarding tea, for example, the water is simple heated in a pot, which is used for consumption. Afterwards the tea is added for the infusion.

There are, however, a great number of popular drinks, which for their preparation require the extraction of a basic material for drinks by means of pressure. In particular, this concerns coffee-mixed drinks, wherein in this espresso method the coffee flour is extracted, for which special devices are necessary. Appropriate brewing methods for using electromagnetic radiation are state of the art.

A device and the associated method for producing drinks by means of electronic radiation are disclosed in the patent application PCT/EP2010/003979.

For producing milk foam there are also different known brewing methods. The most traditional preparation is the foaming-up of milk in a foaming-up container by means of hot vapor. Known methods are automatic foaming-up devices by means of water vapor, for example for fully automatic coffee machines (DE 10134930; DE 3902281; EP 0195750), the use of an aerosol-foaming-up device (US 2004/0076730), or the mechanic whipping of milk.

In the patent application EP 1060701 Converti discloses a coffee brewing unit, which drains the excessive vapor resulting in the brewing container into the collecting container. When this container is filled with a second fluid, for example milk, the second fluid is heated by the vapor and is possibly foamed-up. Since the foaming-up of milk needs more than just adding vapor, by this method there is no expectation to result in a drink comparable to a cappuccino, which is brewed by a barista.

In the patent application US 2004/0020922 Alves discloses a multifunctional boiler, which is good for preparing an extraction drink or a hot drink gained by simple heating of a fluid. In addition, in the patent application U.S. Pat. No. 6,973,870 Alves introduces a milk boiler. Both of these concepts ensure the heating of the drink by electromagnetic radiation up to the boiling point and the keeping the finished drink from further heating. The preparation of mixed drinks from more than one drink component by means of electromagnetic radiation is not possible with this setup, because the collecting container with its opening has to be used partially downwards.

The combination of the preparation steps, meaning the brewing of the extracting drink and the heating of the milk, to one single working step of the consumer, are disclosed by Policappelli in the patent application US 2004/188428 and by Vu et al. in the patent application US 2005/0211102. Thereby more than one brewing chambers are provided, wherein the brewing fluids are simultaneously heated by absorbing electromagnetic radiation. At predetermined conditions resulting from heating, the brewing fluids are pressed for extraction either directly or by a flavored basic material for drinks into a collecting container.

The simultaneous heating of all drink components require an exact composition of the basic materials, if a high drinking quality is to be achieved. This means that the ingredients, the mixture ratio and the temperature are tuned with one another. In this respect, this method is excellent for disposal systems, because the manufacturer can precisely adjust the composition.

With multiple-use devices, which are filled with basic materials by the consumer himself, the drinking quality of a simultaneous preparation of the different drink components depends on the habits and the taste of the consumer. Thereby the preparation unit is filled with basic materials of different characteristics. The composition (e.g. milk with a high or low fat content), the temperature (e.g. cooled milk and water with room temperature) and the filling amount (wherein often the consumer meets the specification only roughly) can vary with every basic material and from preparation to preparation. In this respect, every drink needs its individual way and time of preparation.

There is no satisfying solution for the specific production of milk foam and so for many mixed drinks of milk by means of electromagnetic radiation.

Finally, it is noted that the shielding of the non-heating parts is an important aspect when electromagnetic radiation is used for heating. The basic material for drinks for example may not be burnt and maybe the finished drink may not be further heated and may not be boiled. Existing methods are using solid metal (U.S. Pat. No. 2,601,067, U.S. Pat. No. 4,386,109) or a conductive coating (U.S. Pat. No. 2,601,067) for shielding electromagnetic radiation. Electromagnetic radiation is also known for its characteristic of spreading in openings of conductive coatings, if the opening is below a specific size.

It is an object of the invention for a brewing system for as many different drinks as possible.

It is another object of the invention to ensure a simple, clean and safe handling of the brewing system.

It is a further object of the invention to design all surfaces as accessible as possible for a faster and better cleaning.

It is also an object of the invention that the brewing system be manufactured cost-effective, simple and insusceptible to errors.

In addition, it is an object of the invention that the brewing system enables the producing of mixed drinks with hot milk and milk foam.

The invention has an application in producing drinks by means of electromagnetic radiation.

In particular, the invention has an application with small and portable systems for preparing exclusively single drink portions.

The invention relates to a method with an accompanying brewing system for preparing a mixed drink from two or more drink components, wherein the mixed drink is made up in a collecting container and at least two drink components are prepared by means of electromagnetic radiation. The drink components are prepared in successive steps, and different drink components are on no account exposed simultaneously to electromagnetic radiation. In order to prepare each drink component, the same collecting container is always used for direct collection of the drink components and the drink components already prepared remain in the collecting container during preparation of subsequent drink components.

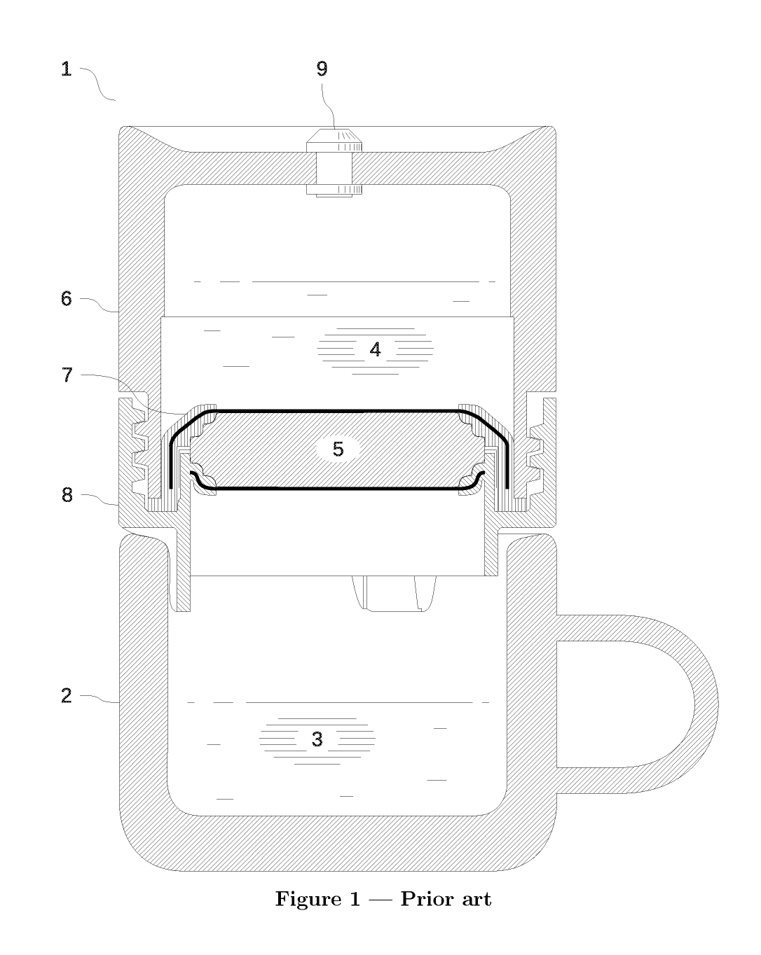

FIGS. 1 to 17 show different examples and details of the invention:

FIG. 1 shows an espresso-brewing unit of the state of the art, as it can be used for producing mixed drinks.

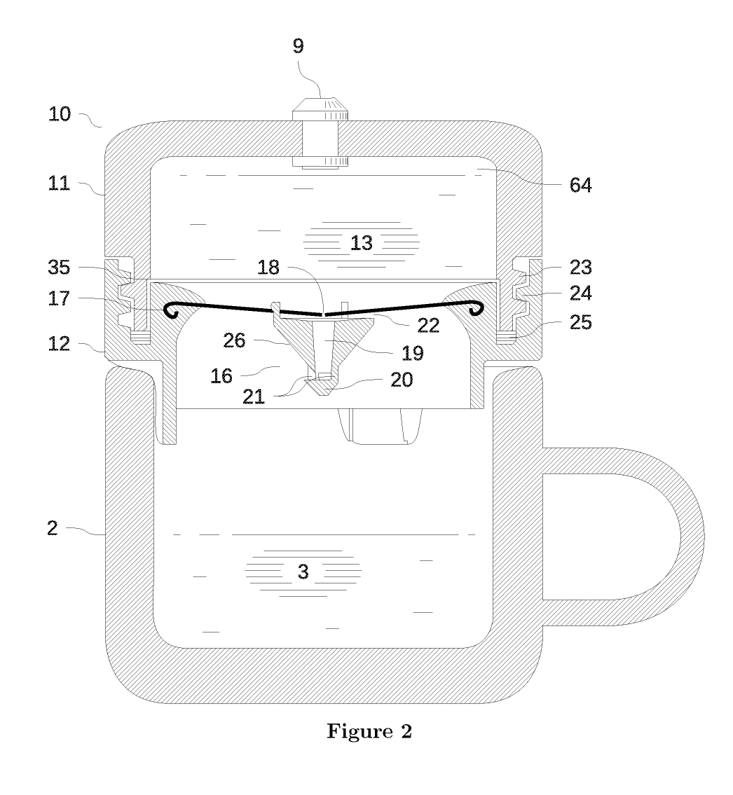

FIG. 2 shows a first example of the inventive brewing unit for hot milk with milk foam before the preparation.

FIG. 3 shows a first example of the inventive brewing unit for hot milk with milk foam after the preparation.

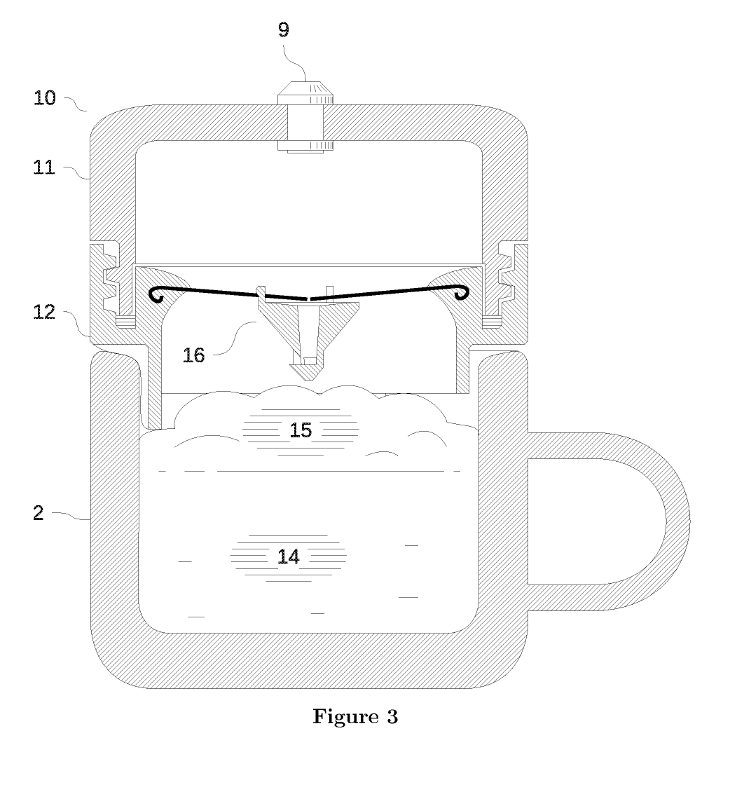

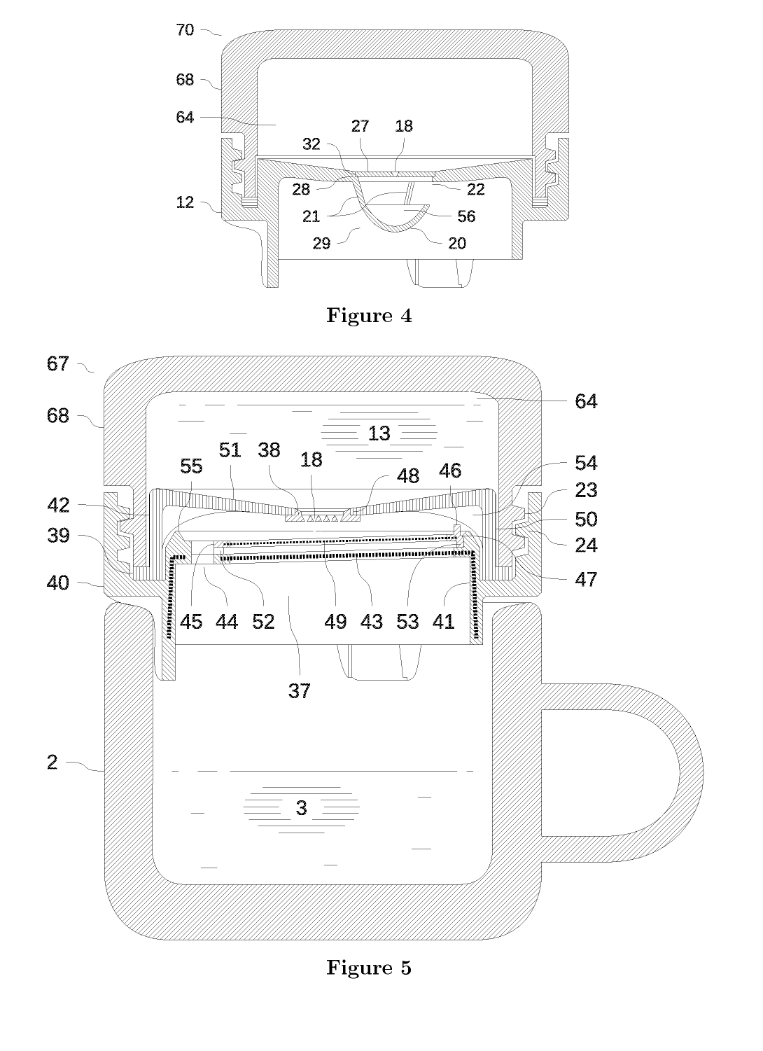

FIG. 4 shows a second example of the inventive brewing unit for hot milk with milk foam.

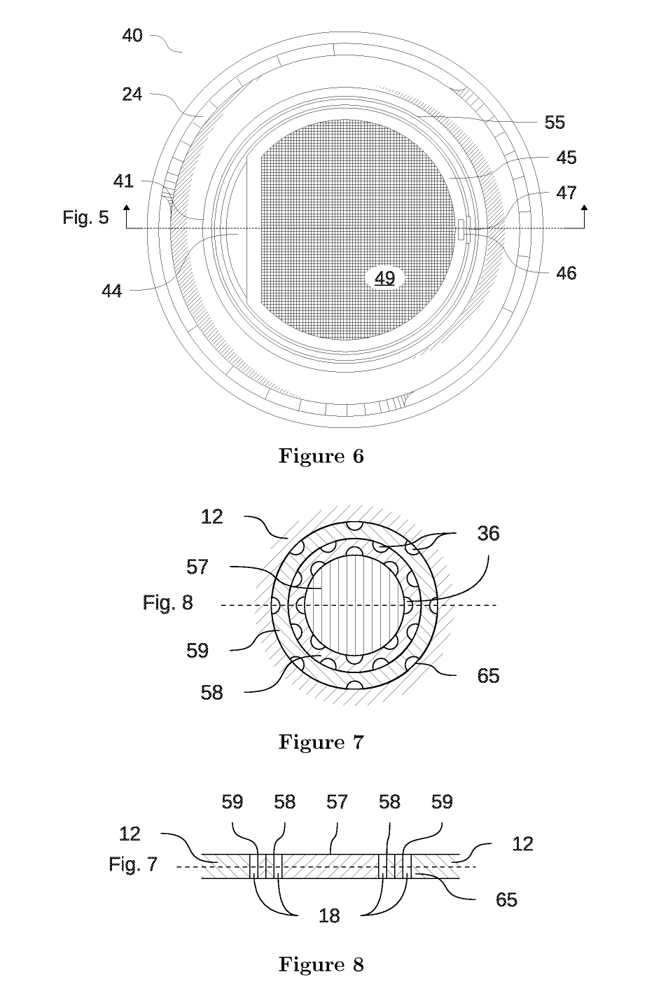

FIG. 5 shows a third example of the inventive brewing unit for hot milk with milk foam.

FIG. 6 shows the closure of FIG. 5 from the top.

FIG. 7 shows a first example of the invention of the nozzles and holes of the filters.

FIG. 8 shows a cross-section of the nozzles or holes of the filters of FIG. 7.

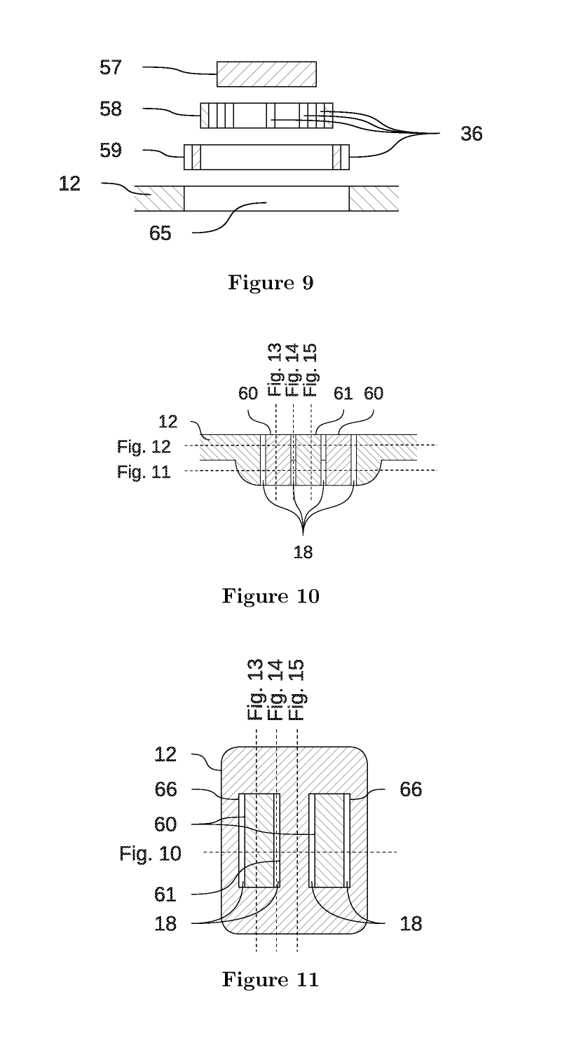

FIG. 9 shows an exploded drawing of the filter elements of FIG. 8.

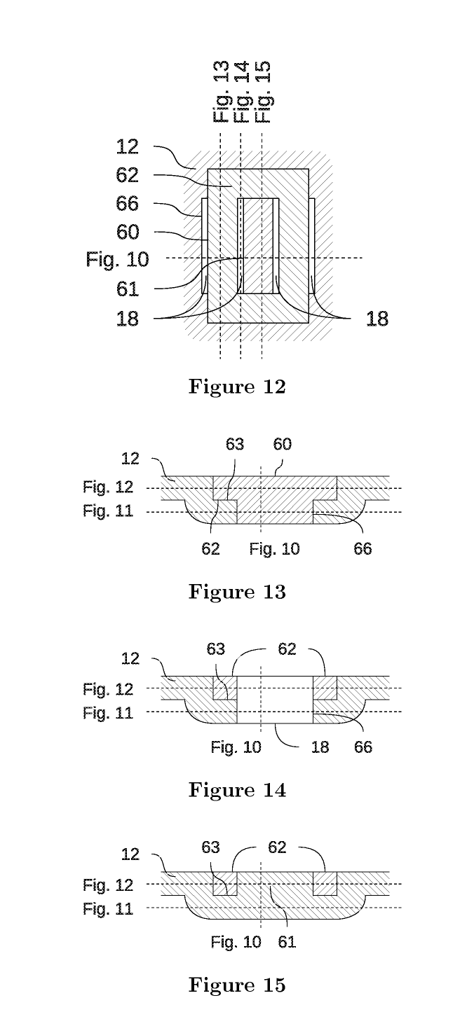

FIGS. 10 to 15 show a second example of the invention of nozzles or holes of the filters in different sectional views.

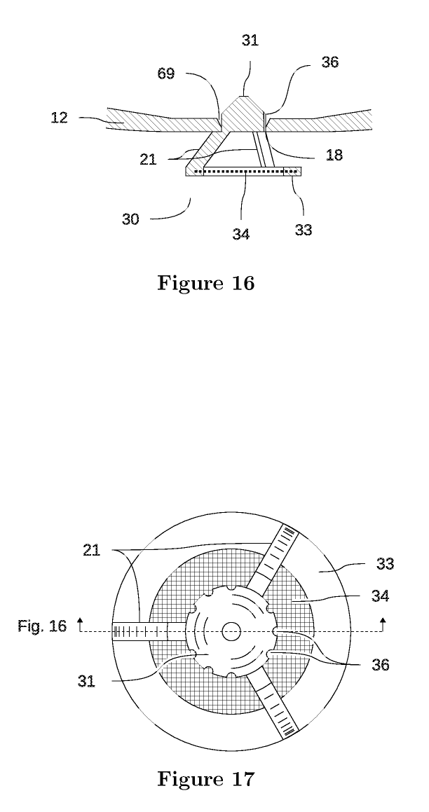

FIG. 16 shows a fourth example of the inventive brewing unit for hot milk with milk foam.

FIG. 17 shows the closure of the fourth example of the inventive brewing unit for hot milk and milk foam.

FIG. 1 shows an example of the patent application PCT/EP2010/003979 for producing drinks by means of electromagnetic radiation. With this application, it is possible to extract flavored basic materials for drinks under pressure. Thus, this application is essential for producing mixed drinks with espresso.

A brewing unit 1 comprises a transparent brewing container 6, a filter element 7 and a filter closure 8, is filled with the brewing fluid 4 and the basic material for drinks and is put on a collecting container 2. When a suitable energy-rich electromagnetic radiation is operating on the ready-made and filled brewing unit 1, the content of the brewing container 6 is heated and an overpressure is created, which presses the hot brewing fluid through the basic material for 30 drinks. The extract drops directly into the collecting container, where the finished drink is collected. The brewing unit 1 is secured by a security device 9, which ensures that the acceptable internal pressure of the brewing container 6 does not exceed.

The collecting container 2 has a device, which prevents or reduces the heating of its content. Such devices are well known in the state of the art and are not carry out further.

FIG. 2 shows a first example of a brewing unit 10 for hot milk with milk foam before the preparation. FIG. 3 shows the first example after the preparation of hot milk and milk foam.

The brewing unit 10 for hot milk and milk foam comprises a transparent brewing container 11 and a closure 12. The brewing container 11 has a characteristic line for filling 35 and a closure device 23, which cooperates with the closure device 24 of the closure 12, wherein the closure devices 23, 24 are threads.

The brewing container 11 and the closure 12 are forming a pressure-tight container 64, wherein, if required, a sealing device 25, for example a flat sealing of rubber, is inserted for sealing the closure spots. The brewing unit 10 for hot milk with milk foam has a security device 9.

The closure 12 comprises a shielding 17 for preventing at least for reducing the irradiation of electromagnetic energy into the openings of the collecting container 2. A foaming-up device 16 is attached at the closure 12 for mixing the milk 13 in such a way with air, that milk foam 15 is resulting. The foaming-up device 16 comprises one or more than one nozzles 18, through which the pressurized milk 13 situated in the brewing container 11 is pressed in a mixed device in shape of a mixed chamber 19.

The body of the foaming-up device 17 comprises a centered mixed chamber 19 and openings 22 for air supply. The jet stopper 20 prevents that the mix of hot milk and milk foam is flowing from the mixed chamber 19 with high speed into the espresso, because this would destroy or at least discolor the foam 15. The jet stopper 20 is connected via holding bars 21 to the body 26.

The innovative method for producing mixed drinks by means of electromagnetic radiation can be exemplary described by the inventive preparation of a cappuccino, that means a mix 14 of espresso and hot milk covered with a layer of milk foam 15.

An espresso 3 is brewed with an espresso-brewing unit 1 in a collecting container 2, suitable for a direct consumption. For this purpose, the preparation unit 1 is disassembled into its components, brewing container 6, filter element 7 and filter closure 8, is filled with a brewing fluid 4 (for the most part with water) and a basic material for drinks 5 (regarding espresso, with coffee flour) and is once again reassembled. The prepared brewing unit 1 is put on a collecting container 2, in this case, a cup, the espresso is brewed by means of microwave oven, and the finished espresso 3 is collected directly in the collecting container 2.

During the preparation of the espresso 3 the brewing unit 10 for hot milk with milk foam can already be prepared. FIG. 2 shows an example for the brewing unit 10 for hot milk with milk foam. The closure 12 is removed from the brewing container 11 before it is filled with milk 13 to the line for filling 35, afterwards the closure 12 is once again put on it.

After the preparation of the espresso 3, the espresso-brewing unit 10 is removed from the collecting container 2 and is replaced by the brewing unit 10 for hot milk with milk foam. The preparation of the mixed drink is continued in the microwave oven with the brewing unit 10 for hot milk and milk foam. Once the milk has completely left the brewing container 11 the cappuccino is ready. The two brewing containers 6, 11 are both transparent. The status of the individual brewing process can be observed any time from the outside, and the finish can be easily determined thereof.

Regarding the context of the invention, the specific order for preparing the drinking components of the mixed drink is insignificant. There are different ways, as mentioned above, for producing the same drink. All of them are realizable by the invention.

The individual brewing units are random combinable. Thus, a particular large variety of drink possibilities is achieved. It is possible to use one brewing unit more than once, for example for producing a double espresso of two single espressos with only one brewing unit. There can be brewed just single milk with milk foam on a double espresso for receiving a stronger coffee mixed drink, as well.

The collecting containers have often different capacities because different drinks have different capacities. In this respect, a person skilled in the art will ensure that all possibilities of the invention can be exploited, for example, that by using adapters, also a narrow brewing unit fits on a wider cappuccino cup. The adapters can have own removable devices but also can be fixed to one of the brewing units. An espresso-brewing unit, for example, is formed at its closure with a permanently connected adapter for different sizes and shapes of cups. The adapters may contain devices for reflecting electromagnetic radiation.

Not all drinking components have to be prepared by means of electromagnetic radiation. There is a version of a drink, for example, interesting for those who are in a hurry: Cold milk is filled in the collecting container and the espresso is brewed therein. Thus, the drink is direct consumable after the brewing of the espresso. Of course, the common and desired milk foam for an espresso drink or a milk mixed drink is still missing.

FIG. 4 shows a second example of the inventive brewing unit 70 for hot milk with milk foam including a second foaming-up device 29. The jet stopper 20 is directly connected via holding bars 21, which define at the same time the openings for air supply 22, to the closure 12. Above the jet stopper 20 there is a hole 32 at the closure 12 with a holding device 28 in shape of a step, which holds a flexible disk. This disk 27 is formed of a elastomer and contains one or more than one nozzles 18. The disk 27 is plugged in the holding device 28 such that within a standard function and use, the disk is holding its position.

The jet stopper 20 is hollow or pot-shaped and comprises the mixture chamber 56. The mixture of milk and milk foam is collected in the mixture chamber 56 and flows into the collecting container 2 as soon as enough milk 13 is flown out of the brewing container 68. The carried air is completely enclosed by the mixture of milk and milk foam. As a result, the carried air is not able to leak to the outside and is scrambled into the milk intensively.

This foaming-up device 29 contains all safety-relevant functions, thus further safety devices are unnecessary. The safety is guaranteed by two types of mechanism:

A first mechanism is provided by using elastic material the nozzles 18 are widened when an increase in pressure occurs inside the brewing container 68, thus the stream through the nozzles 18 will be increased. This effect can also be specifically applied before reaching the safety pressure, for example that there is no significant stream through the nozzles 18 before the working pressure is reached.

A second mechanism is provided by pressing the disk 27 out of the holding device 28 at an overpressure. Thus, a channel with a large cross-section is released through which the content of the brewing container 13 is able to escape. This should be viewed in context with the usage of milk, which coagulates in particular with high temperatures occurred by pressure. At safety mechanisms with small cross-sections, the streams can easily be blocked by milk-coagulating. Thus, those safety mechanisms miss their purpose. It is possible to construct the holding device 28 in such a way, that the disk 27 is released at first at a predefined spot.

It is well known in the state of the art that the interior space of the collecting container 2 is unpressurized in relation to the ambience, and that a pressure balance is enabled at the joints of the brewing unit 1, 10, 67, 70 and the collecting container 2.

To construct the outlet for the safety device in such a way that the content of the brewing container 13 is gushed to the collecting container 2 has particular advantages. The focus is thereby the safety of the consumer. The brewing unit 67, 70 catapults on no account hot fluids or gases, where it could get in contact with the consumer. Further, the surrounding is not getting dirty, but all fluids remain in the brewing unit 67, 70 or in the collecting container 2. Further, the safety function can be combined with the foaming-up function, by which the brewing unit 67, 70 for hot milk with milk foam is manufactured easily and cost-effective.

FIG. 5 shows an example of the invention for a brewing unit 67 for hot milk with milk foam including a foaming-up device 37. The brewing container 68 is closed by a thread 23, 24 of a mixture element 42 and a closure 40 and is forming the pressure chamber 64. FIG. 6 shows the closure 40 from the top.

The mixture element 42 consists of a funnel-shaped disc 51 including a centered hole 48. A nozzle and safety element 38 is inserting in the mixture element 42, which is provided with several nozzles 18. The funnel-shaped disc 51 is kept to the closure 40 by the edge 50 in a defined spacing. An annular flange 39 is attached to the edge 50 on the opposite side of the disc 51, which is clamped between the brewing container 68 and the closure 40. For the better stability of the element there can be attached some lamellar cross reinforcements between the disc 51 and the edge 50.

All sealing devices are attached at the flange 39, for example by appended O-rings or flat sealings. Some parts or the entire element 42 is particularly produced by elastic material, wherein the flange 39 operates as a flat sealing between the brewing container 68 and the closure 40.

The nozzle and safety element 38 is attached by mechanical friction and/or by small undercuts in the hole 48 thereof. Hereby the safety of the brewing unit 67 for hot milk with milk foam is guaranteed, because the nozzle and safety element 38 opens a path with a large cross-section at a predefined excessive pressure in the brewing container 68. The use of other types of connection is possible, as long as the mentioned safety aspect is taken into account.

The nozzles and the safety element 38 do not necessarily have to be combined. The element can be used as a safety device exclusively and the nozzles can be included in the mixture element 42 inseparably.

The closure 40 comprises basically circular frames 41, which carries a strainer 43. The strainer 43 is inserted in such a manner that it falls to one side. At the lowest spot, a hole 44 is left out in the strainer 43 and frame 41 which serves for the exchange of air and fluids. The annular extension 55 at the frame 41 ensures the discharge of the fluid from the spacing between the mixture element 42 and closure 40.

The strainer 43 is preferably made of metal. Hereby the freshly made milk foam 15 as well as the content of the collecting container 2, for example espresso 3, are not further heated. It is the purpose of the shielding effect that the strainer 43 inside the closure is developed as a cup-shape. Thus, in combination with the shielding at the collecting container 2, the energy irradiation into the interior of the collecting container is reduced by shielding as much as possible.

A second, removable frame 45 is inserted into the frame 41, which encompasses a second, non-metal strainer 49 and which keeps a predefined space to the first strainer 43. The frame 45 also leaves the hole 44 clear as well as a slot 52. The handle 46, which is attached to the frame 45, allows the removal of the frame for cleaning. A nose-shaped engagement device 47, which arrests the frame 45 with the closure 40, is preferably located directly next to the handle 46.

The double strainers 43, 49 ensure a good intermixing of the milk with air for resulting a fine milk foam. An efficient cleaning of the brewing unit 67 is possible due to its simple construction. The operator can choose between one or two strainers because of the removable strainer 49, in this way the operator can adjust the quantity of the foam as required. Furthermore, the usage of a removable element 38, for inclusion of the nozzles 18 enables for providing different nozzles and safety elements 38 for different usages, which means that the possible applications for the brewing system are multiplied.

Fine holes are normally used for brewing systems, for example as fine nozzles 18 or holes for filters, whose inventive construction is shown in FIGS. 7 to 15.

Instead of producing fine nozzles 18 or fine holes by filigree tool parts, in the present invention one or more than one elements 57, 58, 59, 60 are manufactured for inserting in a larger hole 65, 66. The elements 57, 58, 59, 60 are in places smaller than the hole 65, 66 generating hollow spaces between the elements 57, 58, 59, 60 and the hole 65, 66.

The cross-section of the hollow spaces between the elements 57, 58, 59, 60 and the hole 65, 66 can take various forms. For example, the cross-sections is tapered towards one direction. Thus, the hollow spaces can have a small opening on the one side and a large opening on the other side.

The molds for producing the elements 31, 57, 58, 59, 60 as well as the hole 32, 65, 66 are due to its construction robust and durable.

The elements 57, 58, 59, 60 can also have the function as a safety device, if they are attached in such a way that they come off at a determined pressure and clear the hole 65, 66 for draining the content of the brewing container. It is possible by one-time breaking of the fixation, if the elements 57, 58, 59, 60 are inserted permanently. Afterwards the brewing unit is unusable. It is more advantageous, if the entire element 57, 58, 59, 60 is construed as a plug connection and can slide out of the hole 65, 66 at an excessively pressure. The operator can return the brewing unit to an operational condition by inserting the element 57, 58, 59, 60 again into the hole 65, 66.

FIGS. 7 to 9 show an application example of the inventive nozzles or holes of the filter. The hole 65 is provided with three elements 57, 58, 59 in total.

The outer element 59 comprises on its outer side grooves 36 and is inserted directly at the hole 65. The outer element 59 has a middle element 58, which comprises on its inner as well on its outer side grooves 36. The inner element 57 is placed in the middle element 58 and comprises no grooves.

The grooves 36 can be of any form and can be located at any desired spot on the elements 57, 58, 59.

FIGS. 10 to 15 show another application example of the inventive nozzles or of the holes of the filter.

A middle bar 61 is located between two rectangular holes 66 and the nozzle element 60 is inserted thereof. The nozzle element 60 comprises two parallel plates, which are connected by a connection linking bar and holding bar 62. The connection linking bar and holding bar 62 is inserted in a corresponding groove 63, which is embedded above and below the holes 66.

The in such a way formed nozzles 18 or holes of the filter are elongated slots. The slots can follow a determined profile, for example a wavy line or a zigzag line.

FIG. 16 shows a third example of the brewing unit 70 for hot milk with milk foam. FIG. 16 shows a foaming-up device 30 comprising an element 31, which locks a hole 69 at the closure 12. The element 31 comprising one or more than one grooves 36, which form with the edge of the hole 32 the nozzles 18. A ring 33 is attached at the holding bar 21 of the element 31, which holds a finely netted strainer 34.

The element 31 has the function of a safety device. If the pressure in the brewing container is too high, the element 31 dissolves out of the hole 32 of the closure 12 and is clearing the path for a fast draining of the content of the brewing container 68.

The person skilled in the art recognizes that the elements 31, 57, 58, 59, 60 can be attached permanently, removable or can be released of the hole 32, 65, 66 only under very certain conditions, for example when using it as a safety device.

For a person skilled in the art it is naturally to use various forms of elements. In addition to the presented forms, the forms of the elements can be oval, triangular, hexagonal, rad-shaped, cross-shaped or star-shaped. The same applies to the form and arrangement of the nozzles 18 and holes of the filter.

Furthermore, it is natural for a person skilled in the art to apply the composition of the nozzles 18 and holes of the filter, as disclosed in the FIGS. 7 to 17, to the brewing units 1, 10, 67, 70, as disclosed in FIGS. 1 to 6.

If not otherwise indicated, all materials of the presented examples of the invention are suitable for microwaves. This means that the materials do not or only insignificantly absorb or reflect the electromagnetic radiation of the commonly used 2.45 GHz. In addition, the possible materials are not restricted and for example, a person skilled in the art can choose materials in the fields of ceramics, glasses or synthetics, according to the requirements.

It is natural for a person skilled in the art to manufacture specific devices partially or entirely out of metal, without affecting the above mentioned functions. The person skilled in the art also knows how to avoid the occurring safety risks when using metal.

Based on the presented foaming-up devices additional examples of the brewing unit 10, 67, 70 for hot milk with foam milk can be developed, which is naturally for a person skilled in the art, but does not deviate from the scope of the invention. In the present description, the mixture device is implemented for example as a mixture chamber or as one or more than one mixture strainers. The mixture device can also be developed otherwise.

In this patent application, for a better understanding the shown devices are rotationally symmetric, however the devices can take arbitrary forms. Also, the cross-sections of various containers, for example the collecting container and the brewing container, may vary considerably from each other. The required constructive deviations from the presented examples are naturally for a person skilled in the art.

It is obvious that other fluids can be foamed-up by the described brewing unit for hot milk with milk foam, which can be implemented by a person skilled in the art due to the presented invention without any further advice.

1. A method for preparing a mixed drink from two or more drink components, wherein the mixed drink is made up in a collecting container (2) and at least two drink components are prepared by means of electromagnetic radiation, characterized in that the drink components are prepared in successive steps, and the brewing units (1, 10, 67, 70) for the drink components are on no account exposed simultaneously to electromagnetic radiation, in order to prepare each drink component, the same collecting container (2) is always used for direct collection of the drink components and the drink components already prepared remain in the collecting container (2) during preparation of the subsequent drink components.

2. The method of claim 1 for preparing a mixed drink from coffee or espresso (3) and hot milk with milk foam (15), characterized in that the coffee or espresso (3) is prepared at first in a collecting container (2) by means of electromagnetic radiation, and the coffee or espresso (3) contained collecting container (2) is used afterwards as a collecting container (2) in order to prepare hot milk and milk foam by means of electromagnetic radiation, completely independent from an espresso brewing method.

3. The method of claim 1 or 2 wherein the milk as a drink component is heated in a brewing container (11, 68) for preparing hot milk with milk foam by means of electromagnetic radiation and wherein the milk is pressed through one or more nozzles (18), characterized in that the ambient air of the milk jets is carried away, the milk and the air are mixed in a mixing device (19, 34, 43, 49, 56) and the hot milk and milk foam are flowing into the collecting container (2).

4. The method of any one of claim 2 or 3, characterized in that instead of milk (13) another liquid, emulsion or suspension is used.

5. A brewing system for preparing a mixed drink from two or more drink components, wherein the mixed drink is made up in a collecting container (2) and at least two drink components are prepared by means of electromagnetic radiation, characterized in that the brewing system comprises:
a) a) a single collecting container (2) used for direct collection of the drink components, and
b) a) at least two independent brewing units (1, 10, 67, 70) from which the actual drink components are pouring out during the brewing process, wherein the brewing units (1, 10, 67, 70) are arranged replaceably and are not simultaneously placeable on the collecting container (2).

6. A brewing system of claim 5 for preparing a mixed drink from coffee or espresso (3) and hot milk with milk foam (15), characterized in that the brewing system comprises an independent brewing unit (1) for coffee or espresso, an independent brewing unit (10, 67, 70) for milk and milk foam and a single collecting container (2).

7. A brewing system of claim 5 or 6 with one or more nozzles (18) in at least one of the brewing units (10, 67, 70) characterized in that a mixing device (19, 34, 43, 49, 56) is attached after the nozzles (18).

8. A brewing system of any one of claims 5 to 7, characterized in that at least one of the brewing units contains fine holes or fine cracks, which are formed by hollow spaces between one or more holes (65, 66, 69), which are bigger than the fine holes or cracks, and one or more elements (31, 57, 58, 59, 60), which are insert in the bigger holes (65, 66, 69).

9. A brewing system of any one of claims 5 to 8, characterized in that a safety device is contained, which comprises of a hole (32, 48, 66, 69), arranged with an safety closure (27, 31, 38, 57, 58, 59) therein, wherein the hole (32, 48, 66, 69) connects the pressure-tight container (64), provided in the brewing unit (1, 10, 67, 70), with the collecting container (2), and wherein the safety closure (27, 31, 38, 57, 58, 59) is attached in the hole (32, 48, 66, 69) such that in case of a too high overpressure the safety closure (27, 31, 38, 57, 58, 59) comes off and releases the hole (32, 48, 66, 69).
